(19) United States
(12) Patent Application Publication
(10) Pub. No.: US 2019/0004762 A1
(43) Pub. Date: Jan. 3, 2019

(54) DISPLAY CONTROL METHOD, COMPUTER-READABLE RECORDING MEDIUM, AND DISPLAY CONTROL APPARATUS

(71) Applicant: FUJITSU LIMITED, Kawasaki-shi (JP)

(72) Inventors: Satoshi Yoshimura, Kouto (JP); Hiroshi Inoue, Ota (JP); Makoto Goda, Warabi (JP)

(73) Assignee: FUJITSU LIMITED, Kawasaki-shi (JP)

(21) Appl. No.: 15/982,047

(22) Filed: May 17, 2018

(30) Foreign Application Priority Data
Jun. 30, 2017 (JP) 2017-129804

(51) Int. Cl. G06F 3/147; G06T 11/60; G06F 17/30; G06Q 30/06

(52) U.S. Cl. CPC G06F 3/147; G06T 11/60; G09G 2370/16; G06Q 30/0633; G06F 17/3028

(57) ABSTRACT

A display control method includes: accepting registration of a target image that is to be displayed on a display unit in a container and that is associated with location information, by a processor; sending, when acquiring the location information on a container or the display unit in the container and identification information on the container or the display unit in the container, the image registered in accordance with the location information to a destination that is associated with the identification information, by the processor; and displaying the image on the display unit in the container, by the processor.

### CROSS-REFERENCE TO RELATED APPLICATION

This application is based upon and claims the benefit of priority of the prior Japanese Patent Application No. 2017-129804, filed on Jun. 30, 2017, the entire contents of which are incorporated herein by reference.

### FIELD

The embodiments discussed herein are related to a display control method, a computer-readable recording medium, and a display control apparatus.

### BACKGROUND

Various methods are used in order for an operator in a facility, such as a theme park, to transmit information to visitors who visit the facility. For example, there is a push notification that pushes information to mobile terminals used by visitors. Furthermore, there is distribution of information performed by using a social networking service (SNS). Furthermore, there is distribution of a mail magazine to each of email addresses of visitors. Furthermore, there is transmission of advertisement placed on a paper medium or information submitted to a message board.

Patent Document 1: Japanese Laid-open Patent Publication No. 2015-168481

However, with a conventional technology for transmitting information to visitors who visit the facility, because the information is transmitted to an indefinite number of people, there is a problem in that it is difficult to transmit, in accordance with the circumstances, information to each of the visitors who visits each area in the facility.

### SUMMARY

According to an aspect of an embodiment, a display control method includes: accepting registration of a target image that is to be displayed on a display unit in a container and that is associated with location information, by a processor; sending, when acquiring the location information on a container or the display unit in the container and identification information on the container or the display unit in the container, the image registered in accordance with the location information to a destination that is associated with the identification information, by the processor; and displaying the image on the display unit in the container, by the processor.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram illustrating the configuration of a display control system including a display control server according to a first embodiment;

FIG. 2 is a functional block diagram illustrating the configuration of an IoT container according to the first embodiment;

FIG. 3 is a functional block diagram illustrating the configuration of the display control server according to the first embodiment;

FIG. 4 is a diagram illustrating an example of the data structure of a container management table according to the first embodiment;

FIG. 5 is a diagram illustrating an example of the data structure of a distribution management table according to the first embodiment;

FIG. 6 is a diagram illustrating an example of the data structure of a distribution rule table according to the first embodiment;

FIG. 7A is a diagram illustrating an example of an image displayed on a display unit in the IoT container;

FIG. 7B is a diagram illustrating another example of an image displayed on the display unit in the IoT container;

FIG. 7C is a diagram illustrating another example of an image displayed on the display unit in the IoT container;

FIG. 7D is a diagram illustrating another example of an image displayed on the display unit in the IoT container;

FIG. 7E is a diagram illustrating another example of an image displayed on the display unit in the IoT container;

FIG. 7F is a diagram illustrating another example of an image displayed on the display unit in the IoT container;

FIG. 8 is a diagram illustrating an example of the sequence of a display control process according to the first embodiment;

FIG. 9 is a diagram illustrating an example of a use purpose of the display control system according to the first embodiment;

FIG. 10 is a functional block diagram illustrating the configuration of a display control system including a display control server according to a second embodiment;

FIG. 11 is a functional block diagram illustrating the configuration of the display control server according to the second embodiment;

FIG. 12 is a diagram illustrating an example of the data structure of a container management table according to the second embodiment;

FIG. 13 is a diagram illustrating an example of the data structure of a distribution management table according to the second embodiment;

FIG. 14 is a diagram illustrating an example of the data structure of a distribution rule table according to the second embodiment;

FIG. 15 is a diagram illustrating an example of the sequence of a display control process according to the second embodiment;

FIG. 16 is a diagram illustrating an example of a use purpose of the display control system according to the second embodiment;

FIG. 17 is a diagram illustrating another example of a use purpose of the display control system according to the second embodiment;

FIG. 18 is a diagram illustrating another example of a use purpose of the display control system according to the second embodiment;

FIG. 19 is a diagram illustrating another example of a use purpose of the display control system according to the second embodiment; and

FIG. 20 is a diagram illustrating an example of a computer that executes the display control program.

### DESCRIPTION OF EMBODIMENTS

Preferred embodiments of the present invention will be explained with reference to accompanying drawings. The present invention is not limited to the embodiments.

### [a] First Embodiment

Configuration of an Operation Management Device

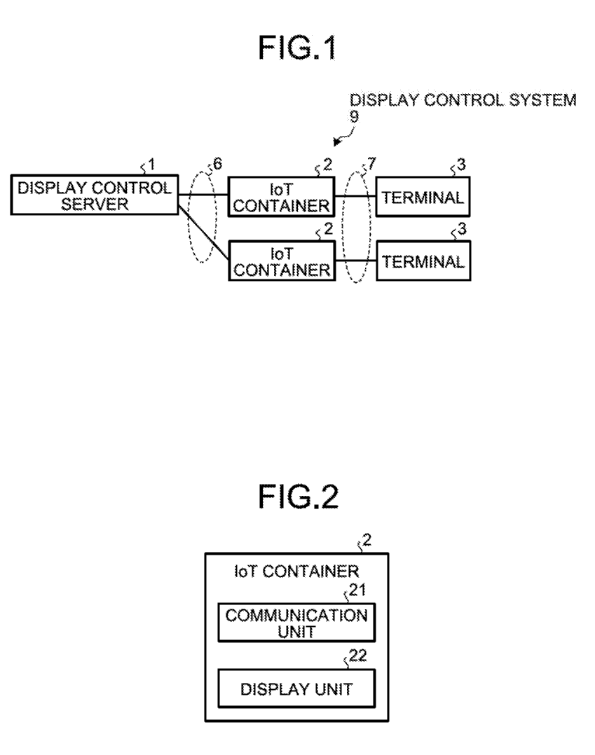

FIG. 1 is a functional block diagram illustrating the configuration of a display control system including a display control server according to a first embodiment. A display control server 1 according to the first embodiment accepts registration of, for example, a target image that is to be displayed on a display unit of an Internet of Things (IoT) container and that is associated with location information. Furthermore, when the display control server 1 receives location information on an IoT container or a display unit in the IoT container and identification information on the IoT container or the display unit in the IoT container, the display control server 1 sends the image that has been registered in accordance with the location information to the destination that is associated with the identification information. Then, the display control server 1 displays the image on the display unit in the IoT container. Namely, the display control server 1 automatically displays, on the display unit in the IoT container, the information, such as an image, in accordance with the location of a user who uses the IoT container. The IoT container mentioned here is a container having both a communication function and a display function and is, in the first embodiment, a container of things to eat and drink provided at a shop that sells take-out things to eat and drink, such as popcorn.

As illustrated in FIG. 1, a display control system 9 according to the first embodiment includes the display control server 1, IoT containers 2, and terminals 3.

The display control server 1 is connected to the IoT containers 2 via a network 6 so as to be communicated with each other. The network 6 mentioned here is, for example, Wi-Fi (registered trademark); however, the network is not limited to this and another communication network, such as a carrier network, may also be used. Furthermore, the IoT containers 2 are connected to the respective terminal 3 via a network 7 so as to be communicated with each other. The network 7 mentioned here is, for example, Bluetooth, such as Bluetooth (registered trademark) Low Energy (BLE); however, the network is net limited to this and any network may be used as long as the IoT containers 2 and the terminals 3 are connected so as to be communicated with each other. The configuration of the display control server 1 will be described later.

The IoT containers 2 are containers each having a communication function, a display function, and a bar code. For example, the IoT containers 2 are containers each of which is capable of displaying an image sent from the display control server 1 on the display unit. Furthermore, the IoT containers 2 are containers each having a bar code in order to distinguish the subject IoT container 2 with the other IoT containers 2. The bar code may also be displayed on the display function or may also be attached to the side surface of the container. The bar code mentioned here corresponds to an IoT container identifier (ID), which will be described later. Furthermore, it has been described that the IoT containers 2 are containers used for take-out things to eat and drink; however, the IoT containers 2 are not limited to this and may also be containers used for beverages, such as mugs or tumblers, or may also be containers used for things to eat and drink including plates or bowls. Furthermore, the configuration of the IoT containers 2 will be described later.

The terminals 3 are an example of terminals used by visitors. The terminals 3 are, for example, mobile phones, such as smartphones; however, the terminals 3 are not limited to this and may also be terminals, such as personal digital assistants (PDAs) or portable personal computers. As an example, any other type of terminals may be used for the terminals 3 as long as each of the terminals can display an application screen that is unique to the facility and fetch and refer to the image displayed on the display unit in the IoT container 2 from the application that is unique to the facility. Furthermore, the application unique to the facility installed in the terminal 3 is sometimes referred to as a “mobile app”.

Configuration of the IoT Container

FIG. 2 is a functional block diagram illustrating the configuration of the IoT container according to the first embodiment. As illustrated in FIG. 2, the IoT container 2 includes a communication unit 21 and a display unit 22.

The communication unit 21 performs communication with the display control server 1 via the network 6 (see FIG. 1). Furthermore, the communication unit 21 performs communication with the terminal 3 via the network 7 (see FIG. 1). The communication unit 21 is implemented by, for example, a network interface card (NIC) or the like.

The display unit 22 displays the image sent from the display control server 1. The display unit 22 is, for example, electronic paper; however, the display unit 22 is not limited to this and any other type of display device may be used as long as a display device is attached to the IoT container 2 and on which an image can be displayed.

Configuration of the Display Control Server

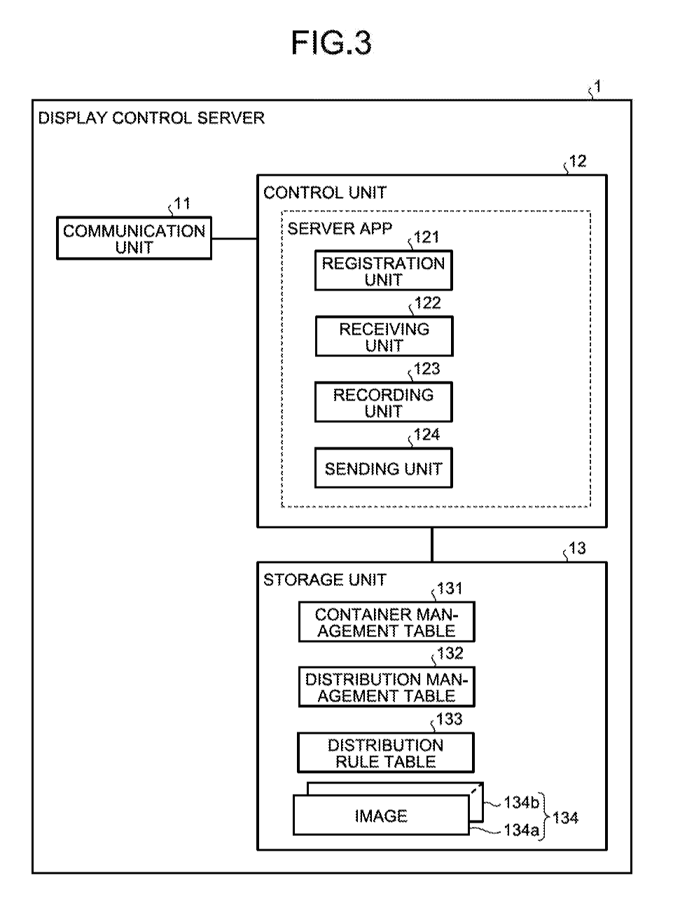

FIG. 3 is a functional block diagram illustrating the configuration of the display control server according to the first embodiment. As illustrated in FIG. 3, the display control server 1 includes a communication unit 11, a control unit 12, and a storage unit 13.

The communication unit 11 performs communication with the IoT containers 2 via the network 6 (see FIG. 1). The communication unit 11 is implemented by, for example, a network interface card (NIC) or the like.

The control unit 12 corresponds to an electronic circuit, such as a central processing unit (CPU). Furthermore, the control unit 12 includes an internal memory that is used to store therein control data and programs in which various kinds of processing procedure are prescribed, whereby the control unit 12 executes various kinds of processes. Here, it is assumed that the control unit 12 performs processes based on a server app. The control unit 12 includes a registration unit 121, a receiving unit 122, a recording unit 123, and a sending unit 124. Furthermore, the sending unit 124 is an example of a display unit.

The storage unit 13 is, for example, a semiconductor memory device, such as a random access memory (RAM) and a flash memory, or a storage device, such as a hard disk and an optical disk. The storage unit 13 includes a container management table 131, a distribution management table 132, a distribution rule table 133, and an image 134. Furthermore, the container management table 131 is an example of a storage unit.

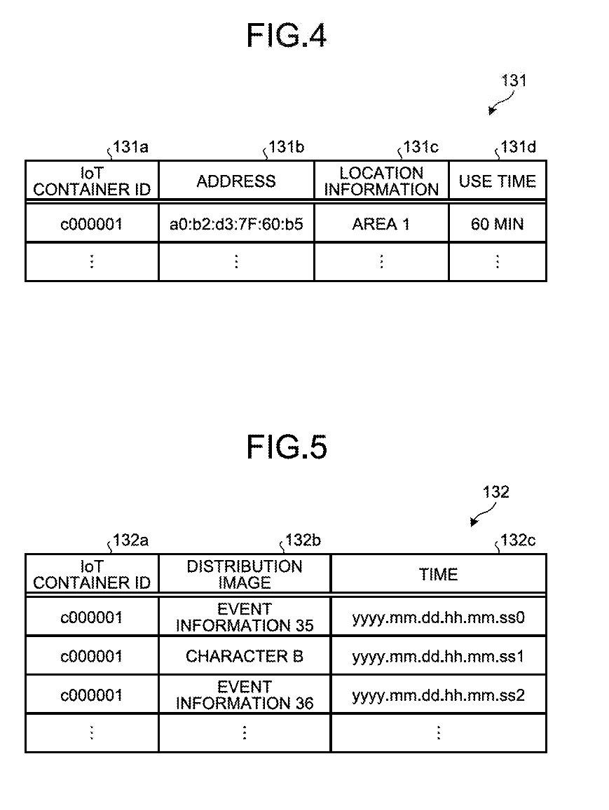

The container management table 131 manages the IoT containers 2. Here, the data structure of the container management table 131 will be described with reference to FIG. 4.

FIG. 4 is a diagram illustrating an example of the data structure of the container management table according to the first embodiment. As illustrated in FIG. 4, the container management table 131 stores therein, in an associated manner, an IoT container ID 131a, an address 131b, location information 131c, and use time 131d. The IoT container ID 131a indicates identification information on the IoT containers 2 or the display unit 22 included in each of the IoT containers 2. The address 131b indicates the address of each of the IoT containers 2. The address 131b is, for example, a media access control (MAC) address; however, the address 131b is not limited to this and any address may be used as long as the address indicates the destination of the IoT container 2. The location information 131c indicates location information on the location of the IoT container 2. The location information mentioned here can be acquired from, for example, information about the installation location of an access point of Wi-Fi to which the IoT container 2 is connected. In contrast, the location information mentioned here is not limited to the information about the installation location of the access point and, alternatively, for example, a global positioning system (GPS) sensor may also additionally be installed in the IoT container 2 and the location information obtained from the GPS sensor may also be used. The use time 131d indicates the time period for which a visitor uses the IoT container 2.

As an example, if the IoT container ID 131a is “c000001”, “a0:b2:d3:7F:60:b5” is stored as the address 131b and an “area 1a” is stored as the location information

A description will be given here by referring back to FIG. 3. The distribution management table 132 manages information on the image distributed to each of the IoT containers 2. Here, the data structure of the distribution management table 132 will be described with reference to FIG. 5.

FIG. 5 is a diagram illustrating an example of the data structure of the distribution management table according to the first embodiment. As illustrated in FIG. 5, the distribution management table 132 stores therein, in an associated manner, an IoT container ID 132a, a distribution image 132b, and time 132c. The IoT container ID 132a indicates identification information on the IoT containers 2 or the display unit 22 included in each of the IoT containers 2. The IoT container ID 132a is associated with the IoT container ID 131a in the container management table 131. The distribution image 132b indicates information for identifying an image distributed to the IoT container 2. In the information for identifying an image, for example, the name of the image or an image number may also be included. The time 132c indicates the time at which the image indicated by the distribution image 132b was distributed.

As an example, if the IoT container ID 132a is “c000001”, “event information 35” is stored as the distribution image 132b and “yyyy.mm.dd.hh.mm.ss0” is stored as the time 132c. Furthermore, if the IoT container ID 132a is “c000001”, a “character B” is stored as the distribution image 132b and “yyyy.mm.dd.hh.mm.ss1” is stored as the time 132c.

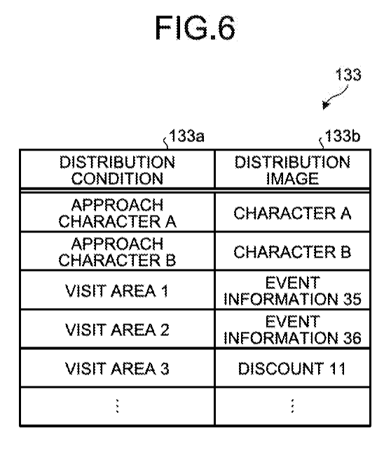

A description will be given here by referring back to FIG. 3. The distribution rule table 133 manages the distribution rule. Furthermore, the distribution rule table 133 may also previously store the distribution rule before the operation of the system or may also perform addition, deletion, a change during the operation of the system. Here, the data structure of the distribution rule table 133 will be described with reference to FIG. 6.

FIG. 6 is a diagram illustrating an example of the data structure of the distribution rule table according to the first embodiment. As illustrated in FIG. 6, the distribution rule table 133 stores therein, in an associated manner, a distribution condition 133a and a distribution image 133b. The distribution condition 133a indicates the condition for distribution of an image. The distribution condition 133a is the condition based on, for example, a mascot character in the facility approached by a visitor or an area in the facility visited by a visitor; however, the condition is not limited to this and another condition may also be used. The distribution image 133b indicates information for identifying the image that is to be distributed when the condition matches the distribution condition 133a. The distribution image 133b is associated with the distribution image 132b in the distribution management table 132.

As an example, if the distribution condition 133a is an “approach to a character A”, the “character A” is stored as the distribution image 133b. If the distribution condition 133a is a “visit to the area 1a”, the “event information 35” is stored as the distribution image 133b.

A description will be given here by referring back to FIG. 3. The image 134 is the image to be distributed. In the following, in order to distinguish a plurality of the images 134, an “image 134a” and an “image 134b” are used for description. In the case where images are not particularly distinguished in a description, the images are referred to as the “image 134”. The image 134 includes, for example, the image 134a in which an illustration, such as a mascot character, is depicted and the image 134b in which a message is described. In the image 134a in which an illustration is depicted, for example, an animated image is included. In the image 134a in which a message is described, for example, information on an event, discount information, free coupon information, or the like is included. The image 134 is created and edited by using an editing terminal (not illustrated) and is registered in the storage unit 13. Furthermore, in the image 134, in addition to the image, characters are also included.

The registration unit 121 in the control unit 12 registers the image 134 in the storage unit 13. For example, if the registration unit 121 accepts the image 134 created by an editing screen of the editing terminal before the operation of the system or during the operation, the registration unit 121 adds the image 134 to the storage unit 13.

If the use of the IoT container 2 is started or purchase of the IoT container 2 has been completed, the receiving unit 122 associates the identification information with the location information on the IoT container 2.

For example, if the receiving unit 122 acquires the identification information on the IoT container 2 when, for example, the use of the IoT container 2 is started, the receiving unit 122 performs the following process. If the acquired identification information is not stored in the IoT container ID 131a in the container management table 131, the receiving unit 122 determines that this indicates the timing at which the use of the container indicated by the acquired identification information was started. Then, the receiving unit 122 stores, in the container management table 131 in an associated manner, the identification information that has been acquired as the IoT container ID 131a; the address, as the address 131b, that is associated with the identification information; and “0” as the use time 131d. Furthermore, the address associated with the identification information may previously be held in the address table.

Furthermore, if the receiving unit 122 acquires the location information from the IoT container 2, the receiving unit 122 stores the location information in the location information 131c that is associated with the IoT container ID 131a currently stored in the container management table 131. Consequently, the receiving unit 122 can associate the identification information with the location information on the IoT container 2. Furthermore, the timing of acquiring the identification information and the location information on the IoT container 2 may also be either the timing at which the use of the IoT container 2 is started or the timing at which purchase of the IoT container 2 has been completed.

The recording unit 123 records the time elapsed after the timing at which the use of the IoT container 2 was started. For example, the recording unit 123 starts a timer at the timing at which the use of the IoT container 2 was started. Then, the recording unit 123 updates the use time 131d that is associated with the IoT container ID 131a in the container management table 131.

The sending unit 124 sends individual images to the IoT containers 2. For example, when the sending unit 124 acquires the identification information and the location information on the IoT container 2 and acquires the image number of the distribution image, the sending unit 124 sends the image based on the acquired image number of the image 134 registered in the storage unit 13 to the destination IoT container 2 associated with the identification information. Consequently, the sending unit 124 can display a unique image that is in accordance with each area visited by a user of the IoT container 2.

Furthermore, the sending unit 124 acquires the IoT container ID 131a of the IoT container 2 from the container management table 131. Then, the sending unit 124 stores information on the sent image in the distribution management table 132 in association with the acquired IoT container ID 131a.

Furthermore, the sending unit 124 changes the image to be displayed on the IoT container 2 in accordance with a predetermined condition. For example, the sending unit 124 changes the image to be displayed on the IoT container 2 in accordance with the area visited by the user of the IoT container 2. As an example, the sending unit 124 refers to the distribution rule table 133 and determines whether or not the location information 131c associated with the IoT container 2 in the container management table 131 matches the distribution condition 133a. Then, if the location information 131c matches the distribution, condition 133a, the sending unit 124 sends the distribution image 133b associated with the matched distribution condition 133a to the destination IoT container 2 that is associated with the IoT container 2 associated with the location information 131c. Consequently, the sending unit 124 can change the image submitted to the IoT container 2 in accordance with the area visited by the user of the IoT container 2.

Image Displayed on the Display Unit in the IoT Container

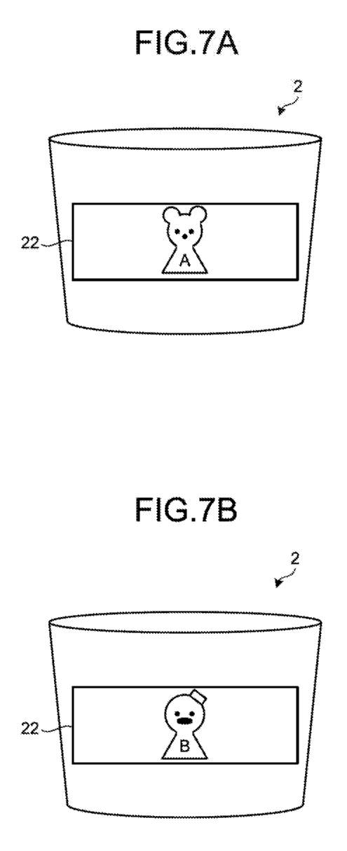

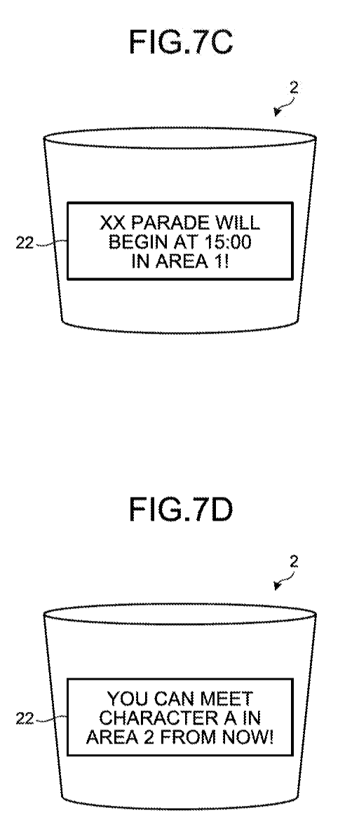

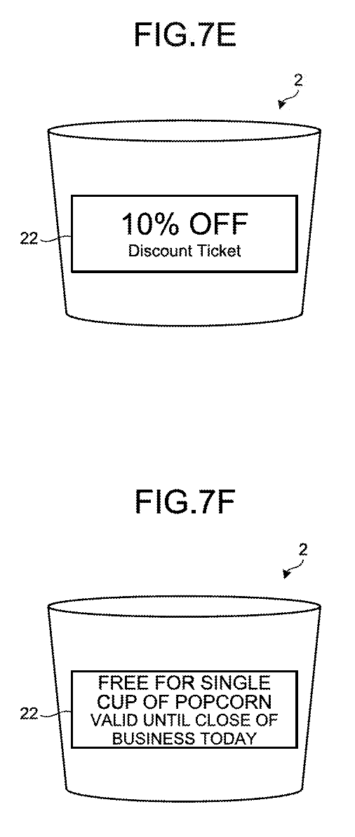

In the following, an example of the image displayed on the display unit 22 in the IoT container 2 will be described with reference to FIGS. 7A to 7F. FIG. 7A is a diagram illustrating an example of the image displayed on the display unit in the IoT container. As illustrated in FIG. 7A, on the IoT container 2, the image indicating a mascot character in the facility is displayed. Here, the character A is displayed as the mascot character in the facility. For example, the sending unit 124 displays, based on the distribution rule table 133, in accordance with the mascot character approached by the user of the IoT container 2, the image of the subject mascot character on the display unit 22 in the IoT container 2.

FIGS. 7B to 7F are diagrams each illustrating another example of the image displayed on the display unit in the IoT container. As illustrated in FIG. 7B, on the IoT container 2, the image indicating another mascot character is displayed. Here, a character B is displayed as another mascot character.

As illustrated in FIG. 7C, on the IoT container 2, the image indicating information on an event is displayed. Here, as information on the event, the message of “XX parade will begin at 15:00 in the area 1a!” is displayed. For example, the sending unit 124 displays, based on the distribution rule table 133, in accordance with the area visited by the user of the IoT container 2, the distribution image of the information on the event on the display unit 22 in the IoT container 2.

As illustrated in FIG. 7D, on the IoT container 2, the image indicating the information on another event is displayed. Here, the message of “You can meet the character A in an area 2a from now!” is displayed as the information on another event.

As illustrated in FIG. 7E, on the IoT container 2, the image indicating the discount information is displayed. Here, as the discount information, “10% OFF” is displayed. For example, the sending unit 124 displays, based on the distribution rule table 133, in accordance with the area visited by the user of the IoT container 2, the distribution image indicating the discount information on the display unit 22 in the IoT container 2.

As illustrated in FIG. 7F, on the IoT container 2, the image indicating the information on the free coupon is displayed. Here, as the information on the free coupon, the message of “free for a cup of popcorn” is displayed. For example, the sending unit 124 displays, based on the distribution rule table 133, in accordance with the area visited by the user of the IoT container 2, the distribution image indicating the information on the free coupon on the display unit 22 in the IoT container 2.

Sequence of a Display Control Process

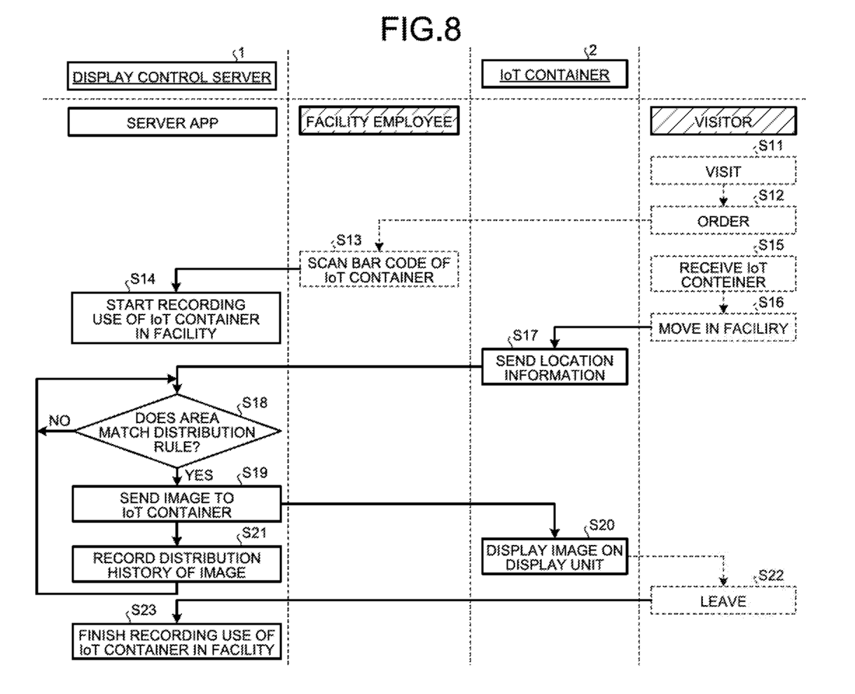

FIG. 8 is a diagram illustrating an example of the sequence of the display control process according to the first embodiment. In FIG. 8, a description will be given of a case in which, if the area to which the visitor who has purchased things to eat and drink moves is matched with the distribution rule, the display control server 1 specifies the image of the advertisement associated with the matched distribution rule and displays the specified image on the IoT container 2 associated with the visitor. Furthermore, the processes indicated by the broken lines illustrated in FIG. 8 are the processes performed by persons.

As illustrated in FIG. 8, a visitor visits the facility and orders things to eat and drink (Steps S11 and S12). An employee in the facility who accepts the order of the things to eat and drink scans, by using the terminal in the facility, the bar code attached to the IoT container 2 (Step S13). The bar code read from the IoT container 2 is the identification information on the IoT container 2. The terminal in the facility that has accepted the operation of the bar code attached to the IoT container 2 acquires the bar code and sends the acquired bar code to the display control server 1.

The display control server 1 that has accepted the bar code starts recording the use of the IoT container 2 associated with the bar code in the facility (Step S14). Namely, the display control server 1 records the time elapsed after the timing at which the use of the IoT container 2 was started. For example, because the bar code is not stored in the IoT container ID 131a in the container management table 131, the display control server 1 determines that this is the timing at which the use of the IoT container 2 was started. Then, the display control server 1 stores, in the container management table 131 in an associated manner, the bar code, the address associated with the bar code, and “0” as the use time. Then, the display control server 1 starts the timer associated with the bar code and records the time elapsed after the timing at which the use of the IoT container 2 was started.

The visitor that has received the identified IoT container 2 with the things to eat and drink moves in the facility (Steps S15 and S16). The IoT container 2 that moves in the facility together with the visitor continuously sends the location information to the display control server 1 (Step S17). The display control server 1 refers to the distribution rule table 133 and determines whether or not the area visited by the visitor matches the distribution rule (Step S18). For example, the display control server 1 refers to the distribution rule table 133 and determines whether or not the location information 131c on the IoT container 2 associated with the container management table 131 matches the distribution condition 133a.

If it is determined that the area visited by the visitor does not match the distribution rule (No at Step S18), the display control server 1 moves the process to Step S18. In contrast, if it is determined that the area visited by the visitor matches the distribution rule (Yes at Step S18), the display control server 1 sends the distribution image associated with the matched distribution rule to the IoT container 2 having the address 131b associated with the location information 131c (Step S19).

The IoT container 2 that has accepted the image displays the image on the display unit 22 (Step S20). In contrast, the display control server 1 that has sent the image records the information on the image sent to the IoT container 2 into the distribution management table 132 as a history (Step S21). For example, the display control server 1 acquires the IoT container ID 131a of the IoT container 2 from the container management table 131. Then, the display control server 1 associates the information on the sent image with the acquired IoT container ID 131a and adds the associated information to the distribution management table 132.

Thereafter, the visitor leaves the facility together with the IoT container 2 (Step S22). The display control server 1 that has accepted a departure of the IoT container 2 ends to record the use of the IoT container 2 in the facility (Step S23). For example, the display control server 1 stops the timer associated with the identification information on the IoT container 2 and ends to record the time elapsed. Furthermore, the exit of the IoT container 2 can be recognized when, for example, the IoT container 2 is lastly connected to the access point installed at the entrance of the facility and, thereafter, the connection of the IoT container 2 is not identified any more in all access points in the facility.

Use Purpose of the Display Control System

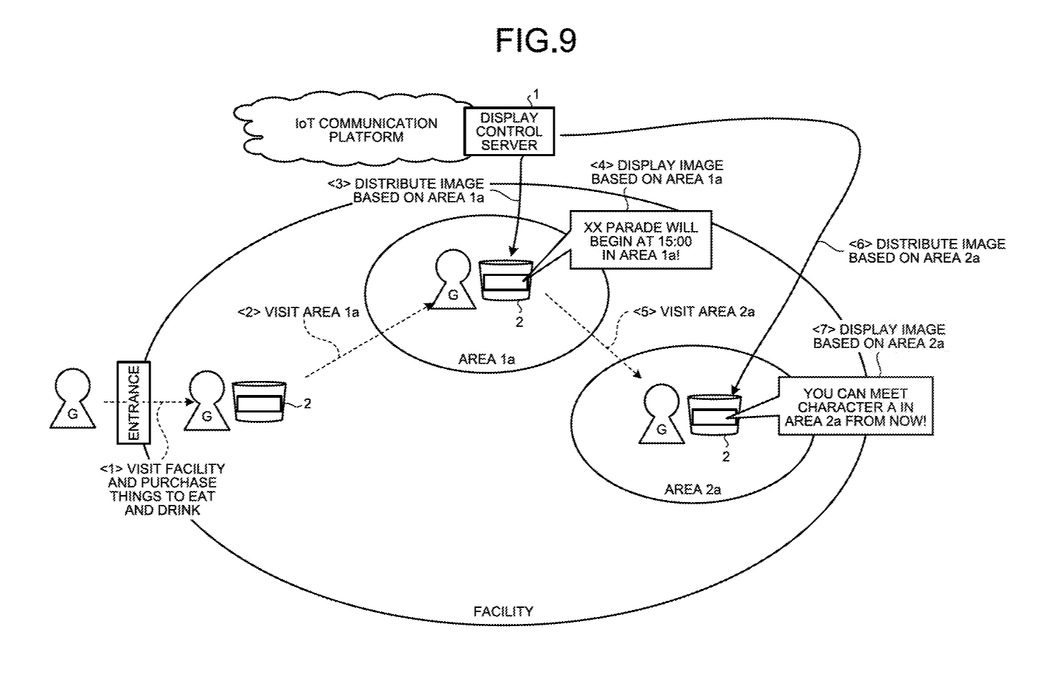

FIG. 9 is a diagram illustrating an example of a use purpose of the display control system according to the first embodiment. FIG. 9 is an example of a facility, such as a theme park. The display control server 1 is connected to the IoT container 2 by Wi-Fi. Furthermore, the IoT container 2 is connected to the terminal 3 by BLE. In the FIG. 9, a description will be given by focusing on a visitor G from among a plurality of visitors.

As illustrated in FIG. 9, <1> the visitor G visits the facility and purchases things to eat and drink contained in the IoT container 2. <2> The visitor G moves in the facility while holding the IoT container 2 and then visits the area 1a in the facility. <3> The display control server 1 receives the location information and the identification information from the IoT container 2 that enters the area 1a. Then, the display control server 1 distributes, based on the received location information and the set distribution rule, the image that is based on the area 1 to the IoT container 2 having the target identification information via Wi-Fi. <4> The IoT container 2 having the target identification information displays the image based on the area 1a (for example, the information on the event illustrated in FIG. 7C).

Furthermore, <5> the visitor G moves in the facility while holding the IoT container 2 and visits the area 2a in the facility. <6> The display control server 1 receives the location information and the identification information from the IoT container 2 that enters the area 2a and updates the location information on the IoT container 2. Then, the display control server 1 distributes, based on the updated location information and the set distribution rule, the image that is based on the area 2a to the IoT container 2 that has the target identification information via Wi-Fi. <7> The IoT container 2 having the target identification information displays the image based on the area 2a (for example, the information on the event illustrated in FIG. 7D).

Consequently, the display control system 9 can display, in accordance with the area visited by the visitor, an image appropriate for the IoT container 2 held by the visitor. For example, if a visitor visits a different area, it is possible to display, on the IoT container 2, an appropriate image that is in accordance with the visited area.

Effect of the First Embodiment

In this way, the display control server 1 accepts the registration of a target image that is to be displayed on the display unit 22 in the IoT container 2 and that is associated with the location information. When the display control server 1 acquires the location information on the IoT container 2 or on the display unit 22 in the IoT container 2 and acquires the identification information on the IoT container 2 or on the display unit 22 in the IoT container 2, the display control server 1 sends the image registered in accordance with the location information to the destination that is associated with the identification information. The display control server 1 displays the image on the display unit 22 in the IoT container 2. With this configuration, the display control server 1 can transmit the information that is in accordance with the status for each IoT container 2 held by each of the visitors who visit each area in the facility.

### [b] Second Embodiment

Configuration of an Operation Management Device

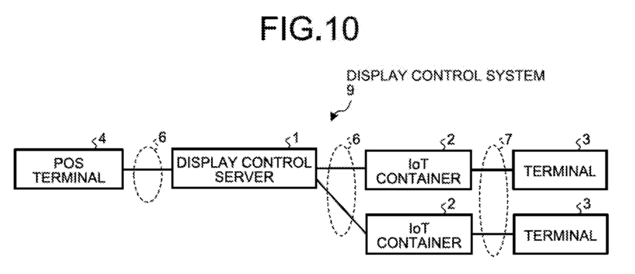

FIG. 10 is a functional block diagram illustrating the configuration of a display control system including a display control server according to a second embodiment. As illustrated in FIG. 10, the display control system 9 according to the second embodiment includes the display control server 1, the IoT containers 2, the terminals 3, and a point of sales (POS) terminal 4. Furthermore, regarding components that are the same as those described in the first embodiment, descriptions thereof will appropriately be omitted.

The display control server 1 is connected to the POS terminal 4 via the network 6 so as to be communicated with each other. Furthermore, the display control server 1 is connected to the IoT containers 2 via the network 6 so as to be communicated each other. The IoT containers 2 are connected to the terminals 3 via the network 7 so as to be communicated with each other. Furthermore, the configuration of the display control server 1 will be described later.

The POS terminal 4 identifies customer information on visitors who visit the facility and makes settlement the sales transaction of the things to eat and drink purchased by the visitors. For example, the POS terminal 4 reads prepaid cards unique to the facility submitted by visitors or reads a bar code of the application screen unique to the facility displayed on each of the terminals 3 that are terminals used by the visitors, which will be described later, and then identifies the customer information on the visitors. Then, the POS terminal 4 makes settlement the sales transaction of the things to eat and drink purchased by the visitors with respect to the customer information. Then, the POS terminal 4 sends the customer information on the visitors to the display control server 1 in order to associate the visitors with the IoT containers 2 that are the containers of the things to eat and drink. Furthermore, the PCS terminal 4 stores the settled settlement information in a storage unit (not illustrated). In the settlement information, for example, the customer information on the visitors, the product names, the prices, purchased time, and the like are included.

Configuration of the Display Control Server

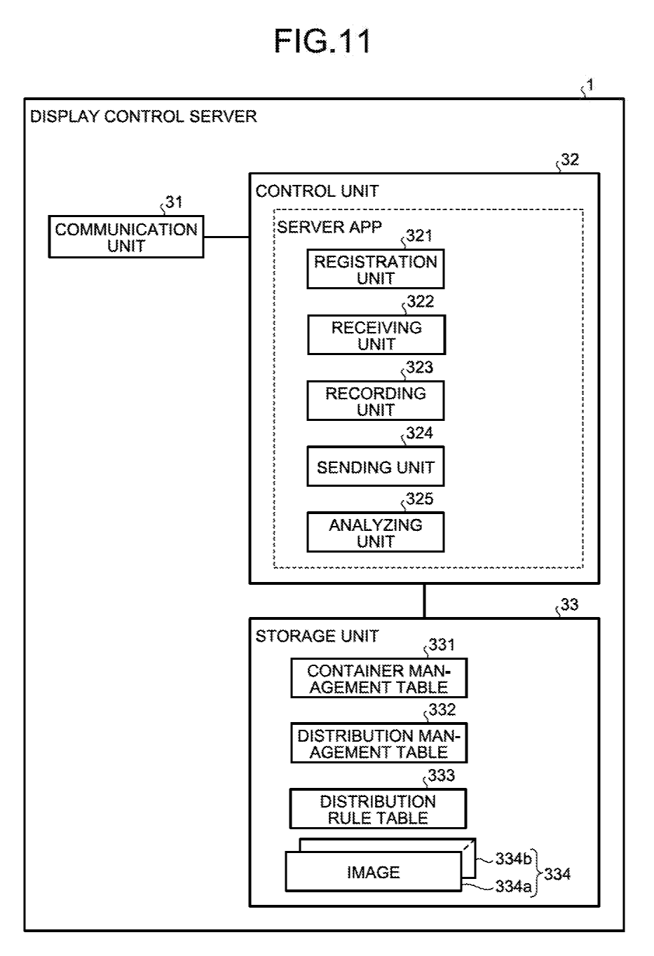

FIG. 11 is a functional block diagram illustrating the configuration of the display control server according to the second embodiment. As illustrated in FIG. 11, the display control server 1 includes a communication unit 31, a control unit 32, and a storage unit 33. Furthermore, the last two digits of the reference numerals are assigned to the same configurations as those described in the first embodiment and descriptions thereof will appropriately be omitted.

The communication unit 31 performs communication with the IoT containers 2 and the POS terminal 4 via the network 6 (see FIG. 10). The communication unit 31 is implemented by, for example, a network interface card (NIC) or the like.

The control unit 32 corresponds to an electronic circuit, such as a central processing unit (CPU). Furthermore, the control unit 32 includes an internal memory that is used to store therein control data and programs in which various kinds of processing procedure are prescribed, whereby the control, unit 32 executes various kinds of processes. Here, it is assumed that the control unit 32 performs processes based on a server app. The control unit 32 includes a registration unit 321, a receiving unit 322, a recording unit 323, a sending unit 324, and an analyzing unit 325. Furthermore, the sending unit 324 is an example of a display unit.

The storage unit 33 is, for example, a semiconductor memory device, such as a random access memory (RAM) and a flash memory, or a storage device, such as a hard disk and an optical disk. The storage unit 33 includes a container management table 331, a distribution management table 332, a distribution rule table 333, and an image 334 (334a, 334b). Furthermore, the container management table 331 is an example of a storage unit.

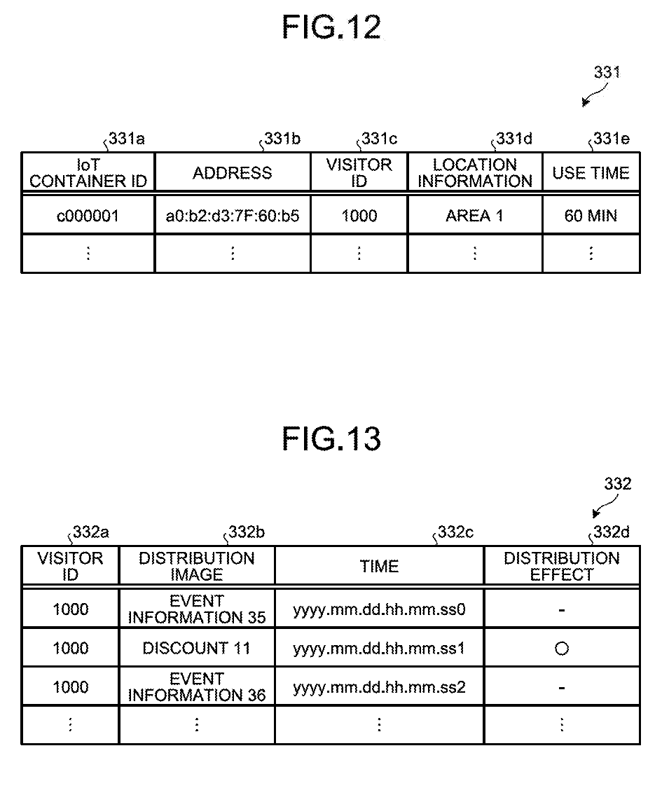

The container management table 331 manages the IoT containers 2. Here, the data structure of the container management table 331 will be described with reference to FIG. 12.

FIG. 12 is a diagram illustrating an example of the data structure of the container management table according to the second embodiment. As illustrated in FIG. 12, the container management table 331 stores therein, in an associated manner, an IoT container ID 331a, an address 331b, a visitor ID 331c, location information 331d, and use time 331e. The IoT container ID 331a indicates identification information on the IoT containers 2 or the display unit 22 included in each of the IoT containers 2. The address 331b indicates the address of each of the IoT containers 2. The visitor ID 331c indicates customer information on visitors. The customer information mentioned here is information indicating, for example, a prepaid card unique to the facility or a bar code of the application screen unique to the facility. The location information 331d indicates the location information on the location of each of the IoT containers 2. The use time 331e indicates the time for which a visitor uses the IoT container 2.

As an example, if the IoT container ID 331a is “c000001”, “a0:b2:d3:7F:60:b5” is stored as the address 331b, “1000” is stored as the visitor ID 331c and the “area 1a” is stored as the location information 331d.

A description will be given here by referring back to FIG. 11. The distribution management table 332 manages information on the image distributed to a visitor. In the following, the data structure of the distribution management table 332 will be described with reference to FIG. 13.

FIG. 13 is a diagram illustrating an example of the data structure of the distribution management table according to the second embodiment. As illustrated in FIG. 13, the distribution management table 332 stores therein, in an associated manner, a visitor ID 332a, a distribution image 332b, time 332c, and distribution effect 332d. The visitor ID 332a indicates the customer information on visitors. The visitor ID 332a is associated with the visitor ID 331c in the container management table 331. The distribution image 332b indicates information for identifying an image distributed to the IoT container 2 associated with a visitor. The time 332c indicates the time at which the image indicated by the distribution image 332b was distributed. The distribution effect 332d indicates information indicating whether or not the distribution image 332b has produced an effect of a new use or purchase. If the effect has been obtained, as an example, “O” is set. Furthermore, regarding the initial value of the distribution effect 332d, as an example, “−” is set.

As an example, if the visitor ID 332a is “1000”, “event information 35” is stored as the distribution image 332b and “yyyy.mm.dd.hh.mm.ss0” is stored as the time 332c. Furthermore, if the visitor ID 332a is “1000”, a “discount 11” is stored as the distribution image 332b, “yyyy.mm.dd.hh.mm.ss1” is stored as the time 332c, and “O” is stored as the distribution effect 332d.

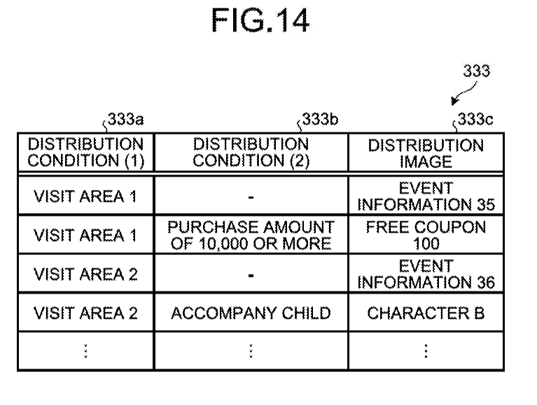

A description will be given here by referring back to FIG. 11. The distribution rule table 333 manages the distribution rule. Here, the data structure of the distribution rule table 333 will be described with reference to FIG. 14.

FIG. 14 is a diagram illustrating an example of the data structure of the distribution rule table according to the second embodiment. As illustrated in FIG. 14, the distribution rule table 333 stores therein, in an associated manner, a distribution condition (1) 333a, a distribution condition (2) 333b, and a distribution image 333c. The distribution condition (1) 333a and the distribution condition (2) 333b indicate the condition for distributing an image. The distribution condition (1) 333a is a condition based on, for example, the area in the facility visited by a visitor or the character in the facility approached by a visitor. The distribution condition (2) 333b is a condition based on, for example, a purchase amount of a product purchased by a visitor in the facility, a purchase history, a purchase area of the product, an accompanying person of the visitor, the progress status of an event, and the like. Furthermore, the distribution condition (1) 333a and the distribution condition (2) 333b are not limited to these and another condition may also foe used. The distribution image 333c indicates information for identifying the image distributed when an image matches the distribution condition (1) 333a and the distribution condition (2) 333b. The distribution image 333c is associated with the distribution image 332b in the distribution management table 332.

As an example, if the distribution condition (1) 333a is a “visit to the area 1a” and the distribution condition (2) 333b is a “purchase amount of 10,000 yen or more”, a “free coupon 100” is stored as the distribution image 333c. If the distribution condition (1) 333a is a “visit to the area 2a” and the distribution condition (2) 333b is “accompanying a child”, the “character B” is stored as the distribution image 333c. Furthermore, in the second embodiment, the distribution condition registered in the distribution rule table 333 is two (the distribution condition (1) 333a and the distribution condition (2) 333b); however, the number of distribution conditions that can be registered in the distribution rule table 333 is not limited two and any number of distribution conditions may also be registered.

A description will be given here by referring back to FIG. 11. The image 334 is an image to be distributed. The registration unit 321 registers the image 334 in the storage unit 33.

If the use of the IoT container 2 is started or purchase has been completed, the receiving unit 322 associates the IoT container 2, the visitor, and the location information.

For example, if the receiving unit 322 acquires the customer information on the visitor from the POS terminal 4, the receiving unit 322 stores the customer information in the visitor ID 331c that is associated with the IoT container ID 331a stored in the container management table 331. Furthermore, if the receiving unit 322 acquires the location information from the IoT container 2, the receiving unit 322 stores the location information in the location information 331d that is associated with the IoT container ID 331a stored in the container management table 331. Consequently, the receiving unit 322 can associate the identification information on the IoT container 2 with the customer information and the location information on the visitor. Furthermore, the timing of acquiring the customer information on the visitor may be either the timing at which the use of the IoT container 2 is started or the timing at which purchase has been completed.

The recording unit 323 records the time elapsed from the timing at which the use of the IoT container 2 was started.

The sending unit 324 sends individual images to the IoT containers 2. For example, when the sending unit 324 acquires the identification information on the IoT container 2, the customer information and the location information, and the image number of the distribution image, the sending unit 324 sends the image that is based on the acquired image number included in the image 334 registered in the storage unit 33 to the destination IoT container 2 associated with the identification information. Consequently, the sending unit 324 can display the image that is in accordance with the customer information on a user of the IoT container 2 and each area visited by the user.

Furthermore, the sending unit 324 acquires the visitor ID 331c of the visitor associated with the identification information on the IoT container 2 from the container management table 331. Then, the sending unit 324 associates the information on the sent image with the acquired visitor ID 331c and stores the associated information in the distribution management table 332.

Furthermore, the sending unit 324 changes, in accordance with a predetermined condition, the image to be displayed on the IoT container 2. For example, the sending unit 324 changes the image to be displayed on the IoT container 2 in accordance with the area visited by the user of the IoT container 2 or the customer information on the user. As an example, the sending unit 324 refers to the distribution rule table 333 and determines whether or not the location information 331d associated with the IoT container 2 in the container management table 331 matches the distribution condition (1) 333a. Furthermore, the sending unit 324 refers to the distribution rule table 333 and determines whether or not the customer information on the visitor ID 331c associated with the IoT container 2 in the container management table 331 matches the distribution condition (2) 333b. Then, if the location information 331d matches the distribution condition (1) 333a and the customer information on the visitor ID 331c matches the distribution condition (2) 333b, the sending unit 324 sends the distribution image 333c that is associated with the matched distribution condition (1) 333a and the distribution condition (2) 333b to the destination IoT container 2 that is associated with the IoT container 2 associated with the location information 331d and the visitor ID 331c. Consequently, the sending unit 324 can change the image to be submitted to the IoT container 2 in accordance with the area visited by the user of the IoT container 2 and the customer information on the user.

The analyzing unit 325 uses the image displayed on the IoT container 2 and analyzes whether or not a new use or purchase has been performed. For example, based on the settlement information accumulated in the POS terminal 4 and the information accumulated in the distribution management table 332, the analysing unit 325 analyzes whether or not the distribution image has produced an effect of a new use or purchase.

As an example, it is assumed that this can be used when the terminals 3 can fetch or refer to the image displayed on the display unit 22 in the corresponding IoT containers 2 from a mobile app. In such a case, if the analyzing unit 325 acquires, from the POS terminal 4, the customer information on a visitor and the image information on the distribution image referred to by using the mobile app, the analyzing unit 325 determines whether or not the acquired image information is set in the distribution image that is associated with the customer information in the distribution management table 332. Then, if the acquired image information is set in the distribution image that is associated with the customer information in the distribution management table 332, the analyzing unit 325 can analyze that a distribution image has produced an effect of a new use or purchase. Then, the analyzing unit 325 sets “O” indicating an effect of the distribution effect 332d associated with the subject distribution image in the distribution management table 332. Furthermore, it is assumed that the analysis performed by the analyzing unit 325 is used in the case where, for example, a visitor newly purchases things to eat and drink or newly uses shops in the facility.

Furthermore, as another example, the analyzing unit 325 may also perform analysis based on determining whether or not, regarding a certain visitor, purchase history is present in the settlement information on the same visitor after the time 332c at which the distribution image 332b has been distributed. Specifically, the sending unit 324 sends, to the IoT container 2 of the visitor based on the distribution rule table 333, an image of discount information indicating “100 yen for a refill of popcorn”. In the distribution management table 332, the sent time 332c associated with the visitor and the image information on the sent discount information are stored. If the history indicating that the same visitor purchased popcorn at 100 yen is recorded in the settlement information after the time 332c, the analyzing unit 325 can analyze that the distribution image has produced an effect of a new use or purchase. Furthermore, analysis performed by the analyzing unit 325 may also be performed by real time processing or performed by batch processing. Consequently, the analyzing unit 325 can analyze some effect of the distribution image.

Sequence of a Display Control Process

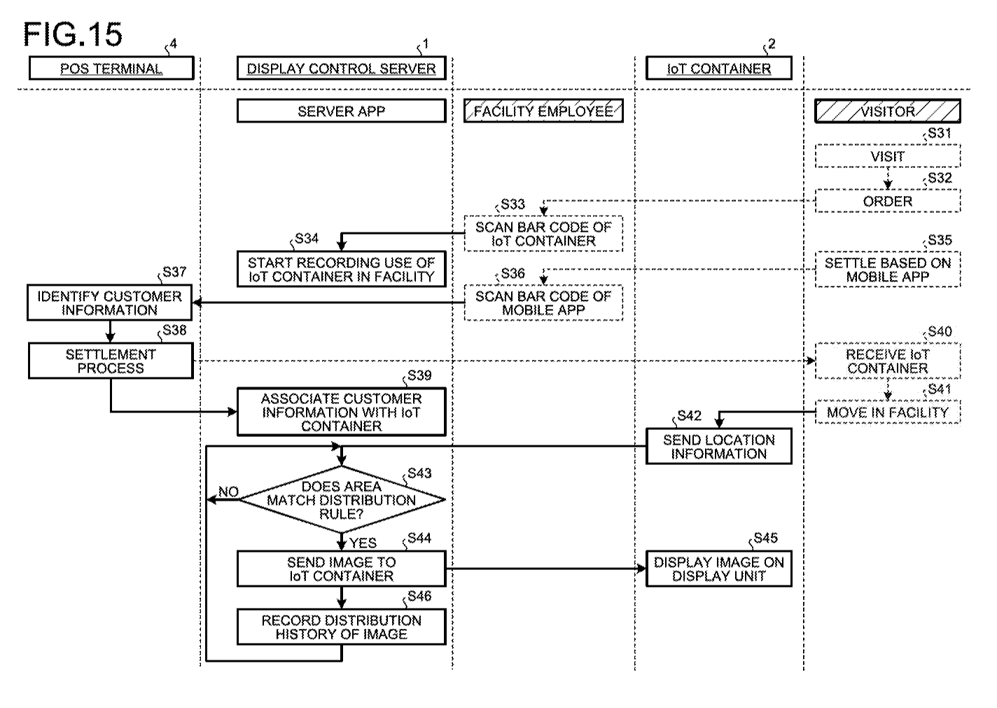

FIG. 15 is a diagram illustrating an example of the sequence of the display control process according to the second embodiment. In FIG. 15, a description will be given of a case in which, if the area to which a visitor who has purchased things to eat and drink has moved and the customer information matches the distribution rule, the display control server 1 specifies the image of the advertisement associated with the matched distribution rule and displays the specified image on the IoT container 2 associated with the visitor. Furthermore, the processes indicated by the broken lines illustrated in FIG. 15 are the processes performed by persons.

As illustrated in FIG. 15, a visitor visits the facility and orders things to eat and drink (Steps S31 and S32). An employee in the facility who accepts the order of the things to eat and drink scans, by using the terminal in the facility, the bar code attached to the IoT container 2 (Step S33). The bar code read from the IoT container 2 is the identification information on the IoT container 2. The terminal in the facility that has accepted the operation of the bar code attached to the IoT container 2 acquires the bar code and sends the acquired bar code to the display control server 1.

The display control server 1 that has accepted the bar code starts recording the use of the IoT container 2 associated with the bar code in the facility (Step S34). Namely, the display control server 1 records the time elapsed after the timing at which the used of the IoT container 2 was started. For example, because the bar code is not stored in the IoT container ID 331a in the container management table 331, the display control server 1 determines that this is the timing at which the use of the IoT container 2 was started. Then, the display control server 1 stores, in the container management table 331 in an associated manner, the bar code, the address associated with the bar code, and “0” as the use time. Then, the display control server 1 starts the timer associated with the bar code and records the time elapsed after the timing at which the used of the IoT container 2 was started.

Furthermore, the visitor makes settlement by using the mobile app installed in the possessing terminal 3 (Step S35). Furthermore, the settlement may also be made by, instead of the mobile app, a prepaid card linked with the mobile app. Then, the employee scans the bar code on the mobile app screen by the terminal in the facility (Step S36). The bar code read from the mobile app screen is the customer information on the visitor.

The POS terminal 4 that has accepted the scan operation of the bar code on the mobile app screen acquires the bar code and identifies the customer information indicating the visitor (Step S37). Then, the POS terminal 4 performs a settlement process (Step S38). Then, the POS terminal 4 sends the acquired customer information to the display control server 1.

The display control server 1 that has accepted the customer information associates the customer information with the IoT container 2 that is started to be used (Step S39). For example, the display control server 1 stores the customer information in the visitor ID 331c associated with the IoT container ID 331a in the container management table 331.

The visitor that has received the identified IoT container 2 together with the things to eat and drink moves in the facility (Steps S40 and S41). The IoT container 2 that moves in the facility together with the visitor continuously sends the location information to the display control server 1 (Step S42). The display control server 1 refers to the distribution rule table 333 and determines whether or not the area visited by the visitor and the customer information on the visitor match the distribution rule (Step S43). For example, the display control server 1 refers to the distribution rule table 333 and determines whether or not the location information 331d associated with the IoT container 2 in the container management table 331 matches the distribution condition (1) 333a. Furthermore, the display control server 1 refers to the distribution rule table 333 and determines whether or not the customer information on the visitor ID 331c associated with the IoT container 2 in the container management table 331 matches the distribution condition (2) 333b.

If it is determined that the area visited by the visitor and the customer information on the visitor do not match the distribution rule (No at Step S43), the display control server 1 moves the process to Step S43. In contrast, if it is determined that the area visited by the visitor and the customer information on the visitor match the distribution rule (Yes at Step S43), the display control server 1 sends the distribution image associated with the matched distribution rule to the location information 331d and the IoT container 2 having the address 331b associated with the visitor ID 331c (Step S44).

The IoT container 2 that has accepted the image displays the image on the display unit 22 (Step S45). In contrast, the display control server 1 that has sent the image records the information on the image sent to the IoT container 2 in the distribution management table 332 as a history (Step S46). For example, the display control server 1 acquires, from the container management table 331, the customer information on the visitor associated with the identification information on the IoT container 2. Then, the display control server 1 associates the information on the sent image with the customer information and adds the associated information to the distribution management table 332.

Use Purpose of the Display Control System

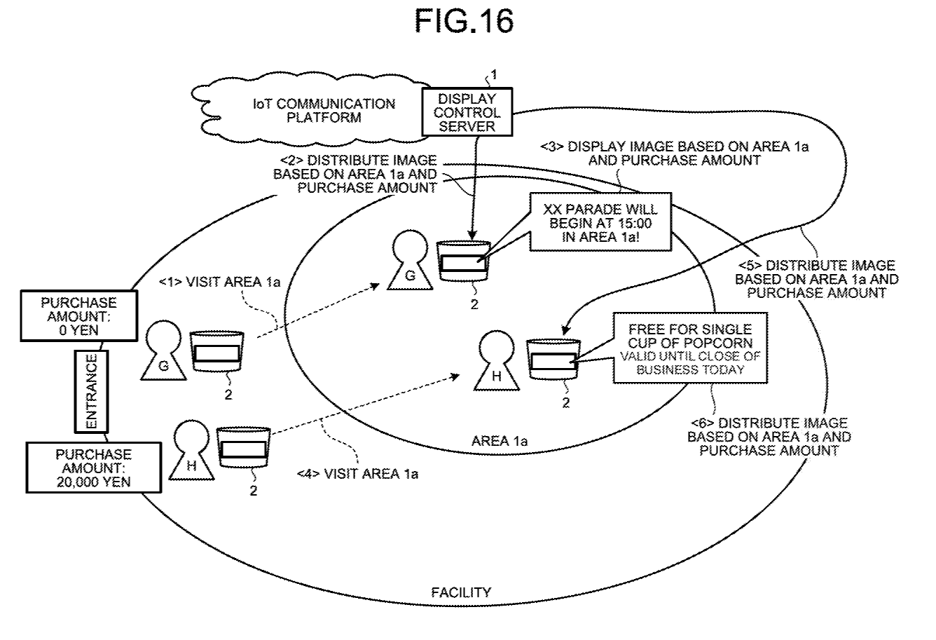

FIG. 16 is a diagram illustrating an example of a use purpose of the display control system according to the second embodiment. Furthermore, the examples illustrated in FIGS. 16 to 18 are examples of a facility, such as a theme park. The display control server 1 is connected to the IoT container 2 by Wi-Fi. Then, the IoT container 2 is connected to the terminal 3 by BLE. In FIG. 16, a description will be given by focusing on the visitor G and a visitor H from among a plurality of visitors.

As illustrated in FIG. 16, <1> the visitor G with a purchase amount of 0 yen in the facility moves in the facility by carrying the IoT container 2 and visits the area 1a in the facility. <2> The display control server 1 receives the location information and the identification information from the IoT container 2 that enters the area 1a. Then, the display control server 1 distributes, based on the received location information and the purchase amount of the visitor G and based on the set distribution rule, the image that is based on the area 1a and the purchase amount (0 yen in this case) to the target IoT container 2. <3> The IoT container 2 displays the image (for example, the event information illustrated in FIG. 7C) that is based on the area 1a and the purchase amount (0 yen in this case).

In contrast, <4> The visitor H with the purchase amount of 20,000 yen in the facility moves in the facility by carrying the IoT container 2 and visits the area 1a in the facility. <5> The display control server 1 receives the location information and the identification information from the IoT container 2 that enters the area 1a. Then, based on the received location information and the purchase amount of the visitor G and based on the set distribution rule, the display control server 1 distributes the image that is based on the area 1a and the purchase amount (20,000 yen in this case) to the target IoT container 2. <6> The IoT container 2 displays the image (for example, the information on the free coupon illustrated in FIG. 7F) that is based on the area 1a and the purchase amount (20,000 yen in this case).

Consequently, the display control system 9 can display, in accordance with the purchase amount of a visitor, an appropriate image on the IoT container 2 held by the visitor. For example, regarding superior customers with a large purchase amount, the display control system 3 can distribute value-added advertisement, such as a free coupon.

Furthermore, the information about the purchase amount of the visitor can be acquired from the customer information on the visitor registered in the PGS terminal 4. Furthermore, the information that can be acquired from the customer information on the visitor registered in the POS terminal 4 is not limited to the information about the purchase amount of a visitor.

For example, the display control server 1 acquires, from the customer information on a visitor, information indicating whether or not the visitor has purchased a predetermined product (for example, information indicating that the visitor has purchased popcorn). Then, based on the received location information and the information about whether or not the visitor G has purchased the predetermined product and based on the set distribution rule, the display control server 1 distributes, to the target IoT container 2, the image that is based on the location information and information about whether or not a predetermined product has been purchased. Then, the IoT container 2 displays the image based on the location information and information about whether or not the predetermined product has been purchased (for example, “100 yen for a refill of popcorn”). Consequently, the display control system 9 can, in accordance with information indicating whether or not the visitor purchased the predetermined product, an appropriate image to the IoT container 2 held by the visitor. For example, the display control system distributes advertisement related to the product purchased by the visitor.

Furthermore, for example, the display control server 1 acquires, from the customer information on the visitor, the information about the purchase history of the visitor (for example, information indicating that a large number of goods related to the character A was purchased up to now). Then, based on the received location information and the information about the purchase history of the visitor G and based on the set distribution rule, the display control server 1 distributes the image that is based on the location information and the purchase history to the target IoT container 2. Then, the IoT container 2 displays the image based on the location information and the purchase history (for example, the information on a new product of goods about the character A). Consequently, the display control system 9 can display, in accordance with the purchase history of the visitor, an appropriate image to the IoT container 2 held by the visitor. For example, based on the purchase track record up to now, the display control system 9 can distribute advertisement related to a product that is highly likely to make the visitor interested in.

Furthermore, for example, the display control server 1 acquires, from the customer information on a visitor, the information about the area in which the visitor has purchased the predetermined product (for example, the information indicating that the goods related to the character B was purchased in the area 2a). Then, based on the received location information and the information about the area in which the visitor G has purchased the predetermined product and based on the set distribution rule, the display control server 1 distributes, to the target IoT container 2, the image based on the location information and the area in which the predetermined product was purchased. Then, the IoT container 2 displays the image based on the location information and the area in which the predetermined product was purchased (for example, the information on an attraction related to the character B in the area 2a). Consequently, the display control system 9 can display, in accordance with the area in which the visitor purchased the predetermined product, an appropriate image on the IoT container 2 held by the visitor. For example, the display control system 9 can distribute, from the area in which the predetermined product was purchased, the advertisement that is highly likely to make the visitor interested in the subject area.

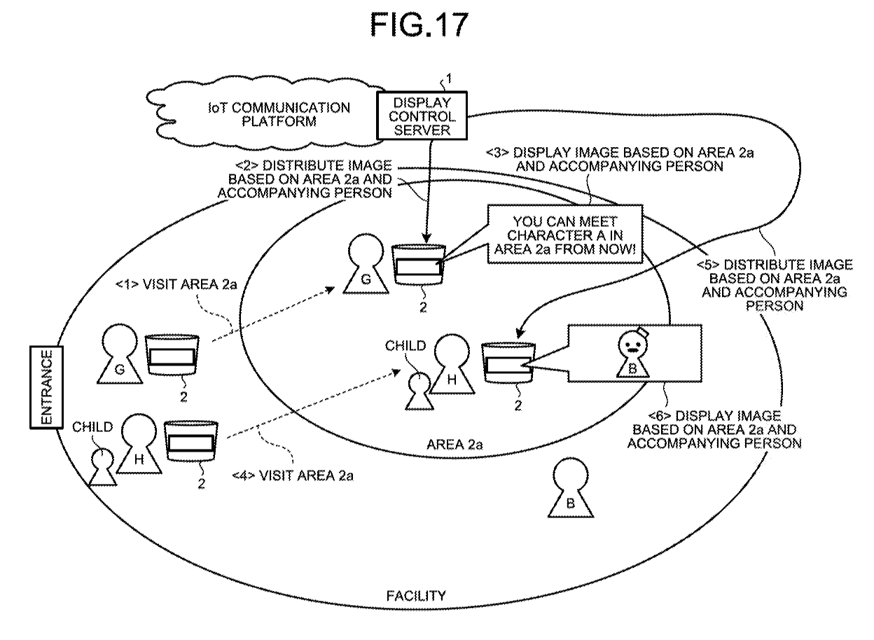

FIG. 17 is a diagram illustrating another example of the use purpose of the display control system according to the second embodiment. In FIG. 17, a description will be given by focusing on the visitor G and the visitor H from among a plurality of visitors.

As illustrated in FIG. 17, <1> the visitor G without an accompanying person moves in the facility by carrying the IoT container 2 and visits the area 2a in the facility. <2> The display control server 1 receives the location information and the identification information from the IoT container 2 that enters the area 2a. Then, based on the received location information and the accompanying person of the visitor G and based on the set distribution rule, the display control server 1 distributes the image that is based on the area 2a and the accompanying person (no accompanying person in this case) to the target IoT container 2. <3> The IoT container 2 displays the image that is based on the area 2a and the accompanying person (no accompanying person in this case) (for example, the event information illustrated in FIG. 7D).

In contrast, <4> the visitor H coming along with a child moves in the facility by carrying the IoT container 2 and visits the area 2a in the facility. <5> The display control server 1 receives the location information and the identification information from the IoT container 2 that enters the area 2a. Then, based on the received location information and the accompanying person of the visitor H and based on the set distribution rule, the display control server 1 distributes the image that is based on the area 2a and the accompanying person (accompanying a child in this case) to the target IoT container 2. <6> The IoT container 2 displays the image that is based on the area 2a and the accompanying person (accompanying a child in this case) (for example, the image of the character B illustrated in FIG. 7B).

Consequently, the display control system 9 can display, in accordance with the accompanying person of the visitor, an appropriate image to the IoT container 2 held by the visitor. For example, regarding the visitor who comes along with a child, the display control system 9 can distribute an image related to a mascot character popular for children.

Furthermore, the information about the accompanying person of the visitor may also be acquired from, for example, the customer information on visitors registered in the POS terminal 4 or may also be input after a facility employee checks, in addition to the things to eat and drink, whether a visitor comes along with someone else when the visitor purchases the IoT container 2.

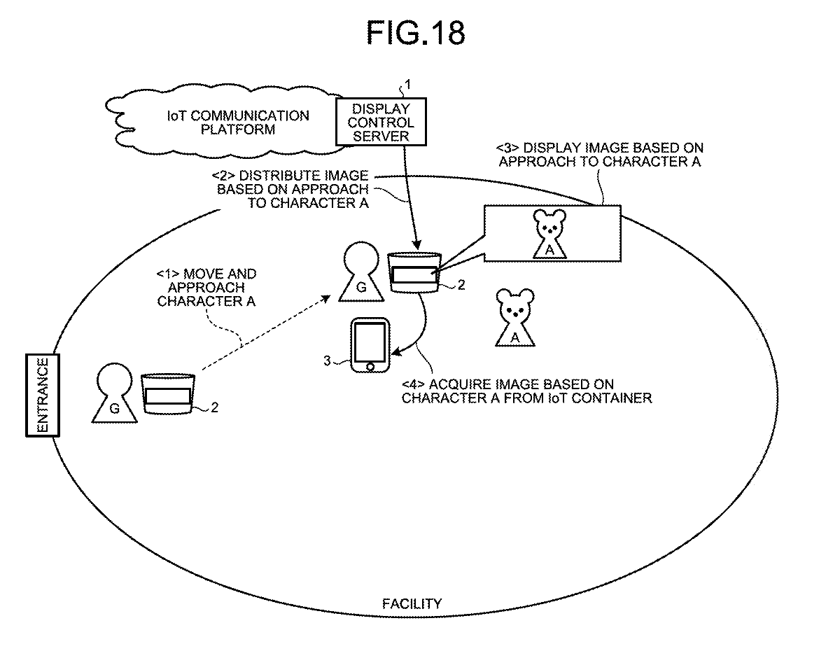

FIG. 18 is a diagram illustrating another example of the use purpose of the display control system according to the second embodiment. In FIG. 18, a description will be given by focusing on the visitor G from among a plurality of visitors.

As illustrated in FIG. 18, <1> the visitor G moves in the facility by carrying the IoT container 2 and approaches the character A that also moves in the facility. <2> The display control server 1 receives the location information and the identification information from the IoT container 2, receives the location information from the character A, and calculates the relative position between the IoT container 2 and the character A. Then, if the IoT container 2 and the character A approach within a predetermined distance, the display control server 1 distributes, based on the set distribution rule, an image that is based on the approaching character A to the IoT container 2 that has the target identification information. <3> The IoT container 2 displays the image based on the approaching character A (for example, the image of the character A illustrated in FIG. 7A). <4> The terminal 3 acquires, from the IoT container 2, the image that is based on the approaching character A (for example, the image of the character A illustrated in FIG. 7A).

Consequently, the display control system 9 can display, in accordance with the moving object approaching a visitor, an appropriate image to the IoT container 2 held by the visitor. For example, if the visitor approaches the mascot character, it is possible to display an appropriate image that is in accordance with the approaching mascot character (for example, the character A) to the IoT container 2. Furthermore, the display control system 9 can store, in accordance with the moving object approaching the visitor, an appropriate image in the terminal 3 held by the visitor.

Furthermore, the moving object described above is not limited to the mascot characters in the facility and may also be, for example, a float (festival float) appearing at the time of event, such as a parade, in the facility.

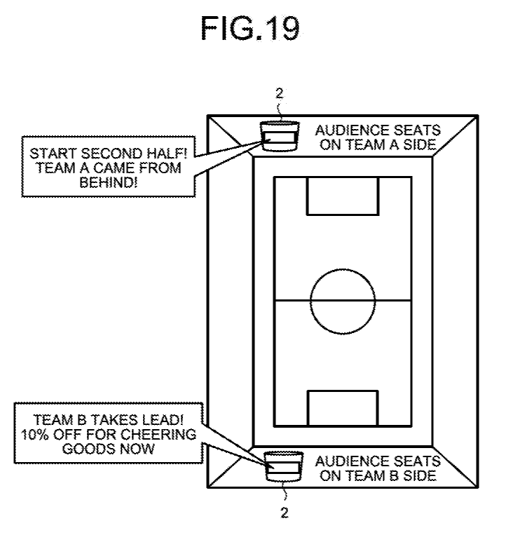

FIG. 19 is a diagram illustrating another example of the use purpose of the display control system according to the second embodiment. FIG. 19 is an example of a sports venue, such as a soccer stadium.

As illustrated in FIG. 19, between a team A and a team B having a game, in the audience seats that support the team A, the display control server 1 receives the location information and the identification information from the IoT containers 2 that are present in the audience seats on the team A side. Then, based on the received location information, based on the progress status on the event that is separately input, and based on the set distribution rule, the display control server 1 distributes the image that is based on the audience seats on the team A side to the target IoT containers 2. Each of the IoT containers 2 displays the image based on the audience seats on the team A side and based on the progress status of the event (for example, “Start the second half! The team A came from behind!”).

In contrast, the display control server 1 receives the location information and the identification information from the IoT containers 2 that are present in the audience seats on the team B side. Then, based on the received location information, based on the progress status on the event that is separately input, and based on the set distribution rule, the display control server 1 distributes the image that is based on the audience seats on the team B side to the target IoT containers 2. Each of the IoT containers 2 displays the image based on the audience seats on the team B side and based on the progress status of the event (for example, “the team B takes a lead! 10% OFF for cheering goods now”).

Consequently, the display control system 9 can display, in accordance with the progress status of the event, an appropriate image to the IoT containers 2 held by the visitors. For example, if the progress of the game reaches a climax, the display control system 9 can display, on the IoT containers 2, an appropriate image that is in accordance with the supporting team (for example, the team A or the team B).

Furthermore, as illustrated in FIG. 19, the facility used in each of the embodiments is not limited to a theme park described above with reference to the drawings up to FIG. 18 and may also be commercial facilities, such as shopping malls, or event facilities, such as sports venues and concert venues. For example, if each of the embodiments is used for a shopping mall or the like, it is possible to distribute, based on the location information and the identification information on the IoT containers 2, advertisement of each shops opened in the shopping mall. Furthermore, if each of the embodiments is used for concert venues or the like, it is possible to distribute, based on the location information and the identification information on the IoT containers 2, the location information, such as concession stands and toilets in the concert venues.

Furthermore, the display control system 9 may also change the image to be displayed on the IoT container 2 in accordance with the time elapsed after the timing at which the use of the IoT container 2 was started. For example, the sending unit 324 refers to the distribution rule table 333 and determines whether or not the use time 331e associated with the IoT container 2 in the container management table 331 matches the distribution condition (1) 333a or the distribution condition (2) 333b. Consequently, the display control system 9 can distribute, in accordance with the elapsed time used by the IoT container 2, the image to be submitted to the IoT container 2.

Furthermore, if the display control system 9 acquires the information on the things to eat and drink provided by the IoT container 2, the display control system 9 may also send the image that is based on the information on the subject things to eat and drink to the IoT container 2. Consequently, by displaying the things to eat and drink ordered by the visitor on the IoT container 2, the display control system 9 can allow the visitor to check the type of the things to eat and drink ordered by the visitor.

Effect of the Second Embodiment

In this way, in the display control server 1, the process of accepting the registration of a target image that is to be displayed on the display unit 22 in the IoT container 2 and that is associated with the location information accepts the registration of the image that is also associated with the information about the purchase of a target product. In the display control server 1, the process of sending the image registered in accordance with the location information acquires the information about a purchase history of a user of the IoT container 2 and sends the image also based on the purchase history to the destination. With this configuration, the display control server 1 can display, in accordance with the purchase history of a visitor, an appropriate image on the IoT container 2 held by the visitor.

Furthermore, in the display control server 1, the process of accepting the registration of the target image that is to be displayed on the display unit 22 in the IoT container 2 and that is associated with the location information accepts the registration of the image that is also associated with whether or not the target product has been purchased. In the display control server 1, the process of sending the image registered in accordance with the location information acquires the information about whether or not the user of the container has purchased the target product and sends the image to the destination also based on the information about whether or not the purchase was made. With this configuration, the display control server 1 can display, in accordance with whether or not the visitor has purchased a predetermined product, an appropriate image on the IoT container 2 held by the visitor.

Furthermore, in the display control server 1, the process of accepting the registration of the target image that is to be displayed on the display unit 22 in the IoT container 2 and that is associated with the location information accepts the registration of the image that is also associated with the purchase area of the target product. In the display control server 1, the process of sending the image registered in accordance with the location information acquires the information about the purchase area in which the user of the container has purchased the target product and sends the image to the destination also based on the purchase area. With this configuration, the display control server 1 can display, in accordance with the area in which the visitor has purchased the predetermined product, an appropriate image on the IoT container 2 held by the visitor.

Furthermore, in the display control server 1, the process of accepting the registration of the target image that is to be displayed on the display unit 22 in the IoT container 2 and that is associated with the location information accepts the registration of the image that is also associated with a purchase amount. In the display control server 1, the process of sending the image registered in accordance with the location information acquires the information about the purchase amount of the user of the container and sends the image to the destination also based on the purchase amount. With this configuration, the display control server 1 can display, in accordance with the purchase amount of the visitor, an appropriate image on the IoT container 2 held by the visitor.

Furthermore, in the display control server 1, the process of accepting the registration of the target image that is to be displayed on the display unit 22 in the IoT container 2 and that is associated with the location information accepts the registration of the image that is also associated with an accompanying person. In the display control server 1, the process of sending the image registered in accordance with the location information acquires the information about the accompanying person of the user of the container and sends the image to the destination also based on the accompanying person. With this configuration, the display control server 1 can display, in accordance with the accompanying person of the visitor, an appropriate image on the IoT container 2 held by the visitor.

Furthermore, in the display control server 1, the process of accepting the registration of the target image that is to be displayed on the display unit 22 in the IoT container 2 and that is associated with the location information accepts the registration of the image that is also associated with a relative position with respect to the moving object. In the display control server 1, the process of sending the image registered in accordance with the location information acquires the location information on the moving object, calculates the relative position between the container and the moving object based on the location information on the moving object, and sends the image to the destination also based on the relative position. With this configuration, the display control server 1 can display, in accordance with the moving object that approaches the visitor, an appropriate image on the IoT container 2 held by the visitor.

Furthermore, in the display control server 1, the process of accepting the registration of the target image that is to be displayed on the display unit 22 in the IoT container 2 and that is associated with the location information accepts the registration of the image that is also associated with a progress status of an event. In the display control server 1, the process of sending the image registered in accordance with the location information acquires the progress status of the event and sends the image to the destination also based on the progress status. With this configuration, the display control server 1 can display, in accordance with the progress status of the event, an appropriate image on the IoT container 2 held by the visitor.

Others

Furthermore, the display control server 1 can be implemented by mounting each of the functions, such as the control unit 12 or 32 and the storage unit 13 or 33, on an information processing apparatus, such as a known personal computer or workstation.

Furthermore, in the embodiments described above, the components of the devices illustrated in the drawings are not always physically configured as illustrated in the drawings. In other words, the specific shape of a separate or integrated device is not limited to the drawings; however, all or part of the device can be configured by functionally or physically separating or integrating any of the units depending on various loads or use conditions. For example, the storage units 13 and 33 may also be connected as an external device of the display control server 1 via a network.

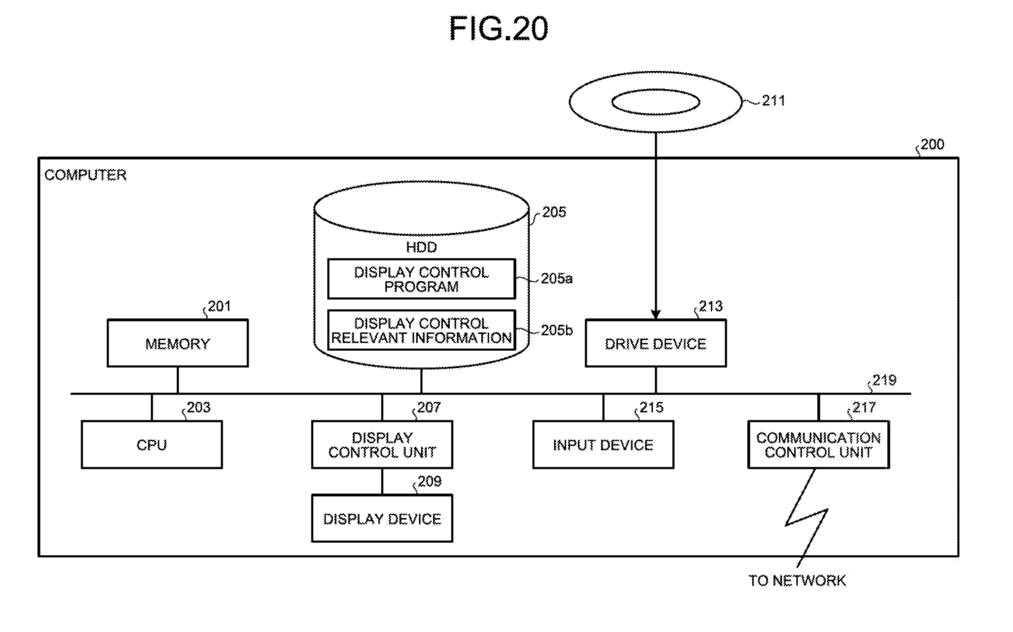

Furthermore, the various processes described above in the embodiments can be implemented by a program prepared in advance and executed by a computer, such as a personal computer or a workstation. Accordingly, in the following, an example of a computer that executes an operation management program that implements the same function as that performed by the display control server 1 illustrated in FIG. 3 or FIG. 11 will be described. FIG. 20 is a diagram illustrating an example of a computer that executes the display control program.

As illustrated in FIG. 20, a computer 200 includes a CPU 203 that executes various kinds of arithmetic processing, an input device 215 that accepts an input of data from a user, and a display control unit 207 that controls a display device 209. Furthermore, the computer 200 includes a drive device 213 that reads programs or the like from a storage medium and a communication control unit 217 that sends and receives data to and from other computers via the network. Furthermore, the computer 200 includes a memory 201 that temporarily stores therein various kinds of information and an HDD 205. Furthermore, the memory 201, the CPU 203, the HDD 205, the display control unit 207, the drive device 213, the input device 215, and the communication control unit 217 are connected by a bus 219.

The drive device 213 is a device used for, for example, a removable disk 211. The HDD 205 stores therein a display control program 205a and display control relevant information 205b.

The CPU 203 reads the display control program 205a, loads the program in the memory 201, and executes the program as a process. The process corresponds to each of the functioning units included in the display control server 1. The display control relevant information 205b corresponds to the container management tables 131 and 331, the distribution management tables 132 and 332, the distribution rule tables 133 and 333, and the images 134 and 334. Then, for example, the removable disk 211 stores therein each of the pieces of information, such as the display control program 205a.

Furthermore, the display control program 205a is not always stored in the HDD 205 from the beginning. For example, the program is stored in a “portable physical medium”, such as a flexible disk (FD), a CD-ROM, a DVD disk, a magneto-optic disk, an IC CARD, or the like, that is to be inserted into the computer 200. Then, the computer 200 may also read and execute the display control program 205a from the portable physical medium.

According to an aspect of an embodiment, it is possible to transmit information in accordance with the status to individual visitors who visit each area in a facility.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A display control method comprising:
accepting registration of a target image that is to be displayed on a display unit in a container and that is associated with location information, by a processor;
sending, when acquiring the location information on a container or the display unit in the container and identification information on the container or the display unit in the container, the image registered in accordance with the location information to a destination that is associated with the identification information, by the processor; and
displaying the image on the display unit in the container, by the processor.

2. The display control method, according to claim 1, wherein
the accepting includes accepting registration of the image that is also associated with information, about purchase of a target product, and
the sending includes acquiring information about a purchase history of a user of the container and sending the image to the destination also based on the purchase history.
3. The display control method according to claim 1, wherein
the accepting includes accepting registration of the image that is also associated with whether or not the target product has been purchased, and
the sending includes acquiring information about whether or not the user of the container has purchased the target product and sending the image to the destination also based on the information about whether or not the purchase was made.

4. The display control method according to claim 1, wherein
the accepting includes accepting registration of the image that is also associated with a purchase area of the target product, and
the sending includes acquiring information about the purchase area in which the user of the container has purchased the target product and sending the image to the destination also based on the purchase area.

5. The display control method according to claim 1, wherein
the accepting includes accepting registration of the image that is also associated with a purchase amount, and
the sending includes acquiring information about the purchase amount of the user of the container and sending the image to the destination also based on the purchase amount.

6. The display control method according to claim 1, wherein
the accepting includes accepting registration of the image that is also associated with an accompanying person, and
the sending includes acquiring information about the accompanying person of the user of the container and sending the image to the destination also based on the accompanying person.

7. The display control method according to claim 1, wherein
the accepting includes accepting registration of the image that is also associated with a relative position with respect to a moving object, and
the sending includes acquiring location information on the moving object, calculating a relative position between the container and the moving object, based on the location information on the moving object, and sending the image to the destination also based on the relative position.

8. The display control method according to claim 1, wherein
the accepting includes accepting registration of the image that is also associated with a progress status of an event, and
the sending includes acquiring the progress status of the event and sending the image to the destination also based on the progress status.

9. A non-transitory computer-readable recording medium having stored therein a program that causes a computer to execute a process comprising:
acquiring, when a use of a specific object on which data is displayed is started or purchase of the object has been completed, location information on the object;
storing the acquired location information on the object in association with identification information on the object; and
displaying data in accordance with the stored location information on the object.

10. The non-transitory computer-readable recording medium according to claim 9, wherein
the acquiring includes acquiring information about a purchase history of a user of the object, and
the displaying includes displaying the data on the object also based on the purchase history.

11. The non-transitory computer-readable recording medium according to claim 9, wherein
the acquiring includes acquiring information about whether or not the user of the object has purchased the target product, and
the displaying includes displaying the data on the object also based on the information about whether or not the purchase was made.

12. The non-transitory computer-readable recording medium according to claim 9, wherein
the acquiring includes acquiring information about a purchase area in which the user of the object has purchased the target product, and
the displaying includes displaying the data on the object also based on the purchase area.

13. The non-transitory computer-readable recording medium according to claim 9, wherein.
the acquiring includes acquiring information about a purchase amount of the user of the object, and
the displaying includes displaying the data on the object also based on the purchase amount.

14. The non-transitory computer-readable recording medium according to claim 9, wherein
the acquiring includes acquiring information about an accompanying person of the user of the object, and
the displaying includes displaying the data on the object also based on the accompanying person.

15. The non-transitory computer-readable recording medium according to claim 9, wherein
the acquiring includes acquiring the location information on a moving object, and
the displaying includes calculating a relative position between the object and the moving object based on the location information on the moving object and displaying the data on the object also based on the relative position.

16. The non-transitory computer-readable recording medium according to claim 9, wherein
the acquiring includes acquiring a progress status of an event, and
the displaying includes displaying the data on the object also based on the progress status.

17. A display control apparatus comprising a processor that executes a process comprising:
acquiring, when a use of a specific object on which data is displayed is started or purchase of the object has been completed, location information on the object;
storing the acquired location information on the object in association with identification information on the object; and
displaying data in accordance with the stored location information on the object.

18. The display control apparatus according to claim 17, wherein
the acquiring includes acquiring information about a purchase history of a user of the object, and
the displaying includes displaying the data on the object also based on the purchase history.

19. The display control apparatus according to claim 17, wherein
the acquiring includes acquiring information about whether or not the user of the object has purchased the target product, and
the displaying includes displaying the data on the object also based on the information about whether or not the purchase was made.

20. The display control apparatus according to claim 17, wherein
the acquiring includes acquiring information about a purchase area in which the user of the object has purchased the target product, and
the displaying includes displaying the data on the object also based on the purchase area.

21. The display control apparatus according to claim 17, wherein
the acquiring includes acquiring information about a purchase amount of the user of the object, and
the displaying includes displaying the data on the object also based on the purchase amount.

22. The display control apparatus according to claim 17, wherein
the acquiring includes acquiring information about an accompanying person of the user of the object, and
the displaying includes displaying the data on the object also based on the accompanying person.

23. The display control apparatus according to claim 17, wherein
the acquiring includes acquiring the location information on a moving object, and
the displaying includes calculating a relative position between the object and the moving object based on the location information on the moving object and displaying the data on the object also based on the relative position.

24. The display control apparatus according to claim 17, wherein
the acquiring includes acquiring a progress status of an event, and
the displaying includes displaying the data on the object also based on the progress status.
